(19) United States
(12) Patent Application Publication
(10) Pub. No.: US 2020/0354249 A1
(43) Pub. Date: Nov. 12, 2020

(54) RECYCLED WATER TREATMENT SYSTEM

(71) Applicant: MEGA UNION TECHNOLOGY INC., Taoyuan City (TW)

(72) Inventors: Kuo-Ching LIN, Taoyuan City (TW); Yung-Cheng CHIANG, Taoyuan City (TW); Shr-Han SHIU, Taoyuan City (TW); Chieh-Yao HOU, Taoyuan City (TW)

(21) Appl. No.: 16/519,606

(22) Filed: Jul. 23, 2019

(30) Foreign Application Priority Data
May 9, 2019 (TW) 108116061

(51) Int. Cl. C02F 9/00

(52) U.S. Cl. CPC C02F 9/00; C02F 2003/003

(57) ABSTRACT

A recycled water treatment system is equipped with different bio-treatment devices to decompose nitrogen-containing inorganic compounds and nitrogen-containing organic compounds in order to enhance efficiency of treating nitrogen-containing organic compounds, wherein an organism-carrying fixed-bed unit is used to efficiently decompose nitrogen-containing organic compounds.

### BACKGROUND OF THE INVENTION

### 1. Field of the Invention

The present invention relates to a water treatment technology, particularly to a recycled water treatment system able to remove ammonia nitrogen and nitrogen-containing organic compounds.

### 2. Description of the Prior Art

Water resources become more and more precious nowadays. Treatment of used water (waste water) and raw water thus grows more and more important. Used water and raw water normally has nitrogen-containing organic compounds. Nitrogen-containing organic compounds impair utilization and reutilization of water and thus must be eliminated. A China patent CN 102781850 B disclosed a water treatment method and an ultra-pure water fabrication method, wherein a carbon source and a microbicide are added to raw water to process raw water beforehand, whereby to increase the efficiency of urea processing and inhibit bacteria from flowing out in the downstream. The method of adding agents and controlling water quality in the downstream is somewhat hard to practice and thus still has room to improve.

### SUMMARY OF THE INVENTION

Herein is provided a recycled water treatment system, which decomposes nitrogen-containing inorganic compounds and nitrogen-containing organic compounds in sequence in a bio-treatment way, wherein nitrogen-containing inorganic compounds are decomposed beforehand lest nitrogen-containing inorganic compounds become competitors in decomposing nitrogen-containing organic compounds.

Accordingly, the present invention proposes a recycled water treatment system, which comprises an ammonia nitrogen removing device, a nitrogen-containing organic compound removing device, and a first device. A first-stage treatment water is input into the ammonia nitrogen removing device to remove ammonia nitrogen to generate a second-stage treatment water. The ammonia nitrogen removing device includes at least one of an aerobic treatment unit and an anoxic treatment unit. The concentration of the ammonia nitrogen in the second-stage treatment water is lower than that in the first-stage treatment water. The second-stage treatment water is input into the nitrogen-containing organic compound removing device to remove nitrogen-containing organic compounds to generate a third-stage treatment water. The nitrogen-containing organic compound removing device includes at least one organism-carrying fixed-bed unit. The concentration of the nitrogen-containing organic compounds in the third-stage treatment water is lower than that in the second-stage treatment water. The third-stage treatment water is input into the first device to undertake at least one of a filtering process and a cation removing process to generate a recycled water.

In one embodiment, the ammonia nitrogen removing device further comprises a membrane treatment unit to undertake soaking of the first-stage treatment water.

In one embodiment, the membrane treatment unit is disposed in the downstream of the aerobic treatment unit and the anoxic treatment unit, outputting the second-stage treatment water.

In one embodiment, the ammonia nitrogen removing device further comprises a pipeline connecting the membrane treatment unit with the aerobic treatment unit and the anoxic treatment unit to make a portion of the first-stage treatment water reflow to the aerobic treatment unit and the anoxic treatment unit.

In one embodiment, the concentration of the ammonia nitrogen in the first-stage treatment water is in the level of 10¹ ppm (mg/L); the concentration of the ammonia nitrogen in the second-stage treatment water is in the level of 10² ppb (μg/L).

In one embodiment, the organism-carrying fixed-bed unit includes an active-carbon fixed bed.

In one embodiment, the nitrogen-containing organic compound removing device further comprise a storage tank disposed between the organism-carrying fixed-bed unit and the ammonia nitrogen removing device for storing the second-stage treatment water.

In one embodiment, the nitrogen-containing organic compounds in the third-stage treatment water include urea at a concentration of 10-15 ppb (μg/L).

Below, embodiments are described in cooperation with the attached drawings to make easily understood the objectives, technical contents, characteristics and accomplishments of the present invention.

### BRIEF DESCRIPTION OF THE DRAWINGS

FIG. 1 schematically shows the configuration of devices and units of a recycled water treatment system according to one embodiment of the present invention; and

FIG. 2 schematically shows the configurations of an ammonia nitrogen removing device and a nitrogen-containing organic compound removing device of a recycled water treatment system according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

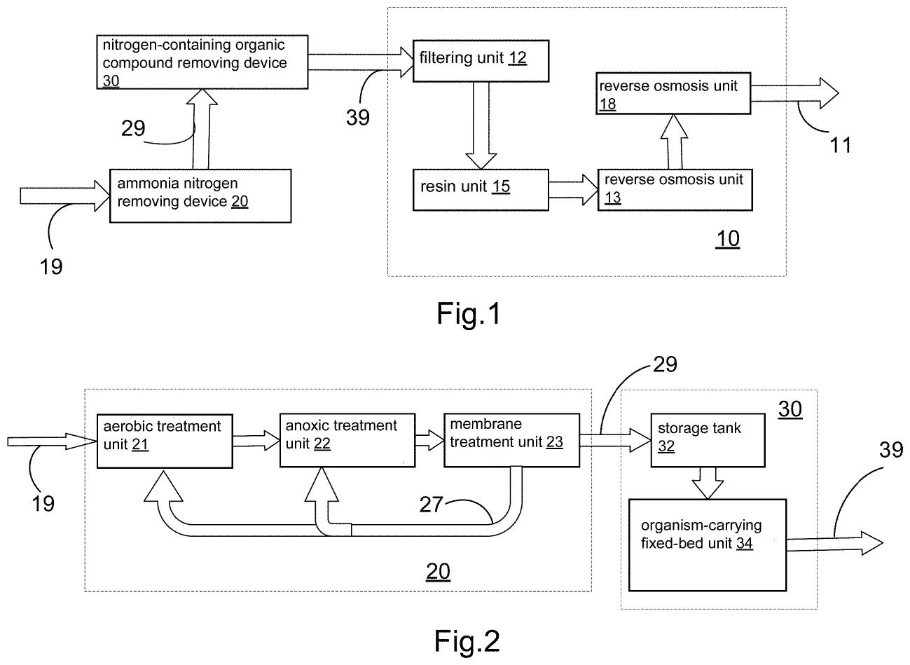

Refer to FIG. 1. The recycled water treatment system of the present invention comprises an ammonia nitrogen removing device 20, a nitrogen-containing organic compound removing device 30, and a first device 10. A first-stage treatment water 19 enters the ammonia nitrogen removing device 20. The ammonia nitrogen removing device 20 removes ammonia nitrogen in the first-stage treatment water 19, which may compete with nitrogen-containing organic compounds, and outputs a second-stage treatment water 29. The second-stage treatment water 29 enters the nitrogen-containing organic compound removing device 30. The nitrogen-containing organic compound removing device 30 removes the nitrogen-containing organic compounds in the second-stage treatment water 29 and outputs a third-stage treatment water 39. The third-stage treatment water 39 enters the first device 10. The first device 10 undertakes a filtering process and a cation removing process. In the present invention, the first device 10 includes the units in the downstream of the ammonia nitrogen removing device 20, including filtering units, units of removing cations, organic compounds, inorganic compounds, bacteria, microbes, etc., and storage units. The units of the first device 10 shown in FIG. 1 are only for exemplification. The sequence (positions in the upstream or downstream of the other units), functions or quantities of these units may be varied, modified or adjusted according to practical requirement, such as the desired quality of the recycled water 11. In the present invention, the recycled water is the reusable water generated via processing waste (sewage) water or discharge water with the system of the present invention.

Refer to FIG. 1 again. In one embodiment, the first device 10 further includes several filtering units, storage units, ion treatment units. The filtering unit 12 in FIG. 1 is an exemplification of the filtering units. The storage unit includes one or more resin column. The ion treatment unit includes a cation (Weak Acid Cation (WAC)) exchange resin unit 15 able to undertake a cation (Weak Acid Cation (WAC)) exchange function and a reverse osmosis unit 18. In one embodiment, the filtering unit 12 is an automatic-cleaning filtering device. For example, the third-stage treatment water 39 is passed through a stainless steel network with meshes of a specified diameter, whereby to realize a continuous filtering function. The functional groups on the surface of the specialized resin is weakly acidic and able to eliminate cations in water. The reverse osmosis unit 13 and the reverse osmosis unit 18 are disposed in sequence to remove most organic compounds, inorganic compounds, bacteria, and microbes; more reverse osmosis units may be used if necessary. The first device 10 processes third-stage treatment water 39 and outputs the recycled water 11.

Refer to FIG. 1 again. In the present invention, the first-stage treatment water 19 contains ammonia nitrogen, nitrogen-containing inorganic compounds, and nitrogen-containing organic compounds, wherein the nitrogen-containing organic compound is mainly urea. In one embodiment, the concentration of the ammonia nitrogen in the first-stage treatment water 19 is in the level of 10¹ ppm (mg/L), for example, the concentration of urea in the first-stage treatment water 19 is 50-1000 ppb (μg/L). In the present invention, the first-stage treatment water 19 is input to the ammonia nitrogen removing device 20 to decompose ammonia nitrogen, whereby to prevent ammonia nitrogen from decreasing the speed and efficiency of processing nitrogen-containing organic compounds in the succeeding processing steps. The first-stage treatment water 19 is the water source of the recycled water treatment system of the present invention and may be a systematic reclaimed water or a non-systematic reclaimed water. The systematic reclaimed water is the waste water or discharge water reclaimed from the sewer system; the non-systematic reclaimed water is the waste water or discharge water not released to the sewer system.

Refer to FIG. 2 a diagram schematically showing the configurations of the ammonia nitrogen removing device 20 and the nitrogen-containing organic compound removing device 30 according to one embodiment of the present invention. As shown in FIG. 2, the ammonia nitrogen removing device 20 includes several bio-treatment units: at least one aerobic treatment unit 21, at least one anoxic treatment unit 22, and at least one membrane treatment unit 23. In one embodiment, the first-stage treatment water 19, which is at a pH value of 6-9, is input into the aerobic treatment unit 21 through a pipeline; the aerobic organism/microbes in the aerobic treatment unit 21 decompose the ammonia nitrogen (inorganic compounds) in the first-stage treatment water 19. The present invention does not limit the growth way of the aerobic organism/microbes in the aerobic treatment unit 21, and they may grow in a suspension way or in an attachment way. Next, the processed water enters the anoxic treatment unit 22 where an aeration treatment and an anoxic treatment are undertaken. Next, the processed water enters the membrane treatment unit 23 where the processed water is soaked and the dissolved oxygen concentration is controlled. In the present invention, nutrients may be optionally added to the processed water in the membrane treatment unit 23 to favor the succeeding bio-treatments. However, nutrient addition is not indispensable in the present invention. It is a choice in the present invention: a portion of the processed water in the membrane treatment unit 23 reflows through a pipeline 27 to the aerobic treatment unit 21 and the anoxic treatment unit 22 for treatment once again. It should be explained herein: the ammonia nitrogen removing device 20 of the present invention is primarily to decompose ammonia nitrogen; however, the ammonia nitrogen removing device 20 is not limited to only decompose ammonia nitrogen. The reason why the device is named the ammonia nitrogen removing device is that the ammonia nitrogen concentration in the second-stage treatment water 29 is obviously lower than that in the first-stage treatment water 19. For example, the ammonia nitrogen concentration in the second-stage treatment water 29 is below 10² ppb (μg/L). The fact that the ammonia nitrogen concentration in the second-stage treatment water 29 is obviously lowered (even to an extent free of ammonia nitrogen) favors the nitrogen-containing organic compound removing device 30 to decompose/remove the nitrogen-containing organic compounds in the second-stage treatment water 29. It is easily understood: although the ammonia nitrogen removing device 20 can also decompose nitrogen-containing organic compounds, it is not the main function of the ammonia nitrogen removing device 20 in the present invention.

Refer to FIG. 2 again. The nitrogen-containing organic compound removing device 30 includes at least one organism-carrying fixed-bed unit 34. The second-stage treatment water 29 is transferred to a storage tank 32 and then released to the nitrogen-containing organic compound removing device 30 where urea (a nitrogen-containing organic compound) in the second-stage treatment water 29 is decomposed. In one embodiment, the ammonia nitrogen concentration in the second-stage treatment water 29 has been decreased to a level of 10² ppb (μg/L). Therefore, the ammonia nitrogen will not compete with urea (a nitrogen-containing organic compound) in the nitrogen-containing organic compound removing device 30. The microbes in the nitrogen-containing organic compound removing device 30 may decompose urea aerobically. The organism-carrying fixed-bed unit 34 may include a fixed bed with microbes. For example, bonded active carbon is used as a filtering bed, and microbes adhere to the active carbon, and the combination can decompose urea. Therefore, while the second-stage treatment water 29 is transferred to the organism-carrying fixed-bed unit 34, the urea in the second-stage treatment water 29 is absorbed by the fixed bed and decomposed by the microbes. The products of urea decomposition will nor block the active carbon but can be carried away by water. Therefore, the present invention can solve the problem that the conventional active carbon column needs maintenance to activate active carbon. After the urea in the second-stage treatment water 29 is decomposed by the organism-carrying fixed-bed unit 34, the urea concentration in the third-stage treatment water 39 output by the nitrogen-containing organic compound removing device 30 is obviously lowered. For example, the urea concentration in the third-stage treatment water 39 is 10-15 ppb (μg/L). In the present invention, if the urea in the recycled water 11 needs further decreasing, appropriate devices may be disposed in the first device 10 to process the third-stage treatment water 39.

1. A recycled water treatment system comprising:
an ammonia nitrogen removing device, wherein a first-stage treatment water is input into the ammonia nitrogen removing device, and wherein the ammonia nitrogen removing device removes ammonia nitrogen in the first-stage treatment water and outputs a second-stage treatment water, and wherein the ammonia nitrogen removing device includes at least one of an aerobic treatment unit and an anoxic treatment unit, and wherein a concentration of the ammonia nitrogen in the second-stage treatment water is in a level of 10² ppb (μg/L) which is lower than a concentration of the ammonia nitrogen in the first-stage treatment water;
a nitrogen-containing organic compound removing device, wherein the second-stage treatment water is input into the nitrogen-containing organic compound removing device, and wherein the nitrogen-containing organic compound removing device removes urea in the second-stage treatment water and outputs a third-stage treatment water, and wherein the nitrogen-containing organic compound removing device at least includes an organism-carrying fixed-bed unit, and wherein a concentration of 10-15 ppb (μg/L) of the urea in the third-stage treatment water is lower than a concentration of the urea in the second-stage treatment water; and
a first device, wherein the third-stage treatment water is input into the first device, and the first device undertakes at least one of a filtering process and a cation removing process to generate a recycled water.

2. The recycled water treatment system according to claim 1, wherein the ammonia nitrogen removing device further includes a membrane treatment unit for soaking the first-stage treatment water.

3. The recycled water treatment system according to claim 2, wherein the membrane treatment unit is disposed in a downstream of the aerobic treatment unit and the anoxic treatment unit and outputs the second-stage treatment water.

4. The recycled water treatment system according to claim 3, wherein the ammonia nitrogen removing device further includes a pipeline connecting the membrane treatment unit with the aerobic treatment unit and the anoxic treatment unit to make a portion of the first-stage treatment water reflow to the aerobic treatment unit and the anoxic treatment unit.

5. The recycled water treatment system according to claim 1, wherein the concentration of the ammonia nitrogen in the first-stage treatment water is in a level of 10¹ ppm (mg/L).

6. The recycled water treatment system according to claim 1, wherein the organism-carrying fixed-bed unit includes an active-carbon fixed bed.

7. The recycled water treatment system according to claim 1, wherein the nitrogen-containing organic compound removing device further includes a storage tank disposed between the organism-carrying fixed-bed unit and the ammonia nitrogen removing device for storing the second-stage treatment water.

8. (canceled)
